(19) United States
(12) Patent Application Publication
(10) Pub. No.: US 2015/0102670 A1
(43) Pub. Date: Apr. 16, 2015

(54) METHOD FOR OPERATING BOOTING AND ELECTRONIC DEVICE THEREOF

(71) Applicant: Samsung Electronics Co., Ltd., Gyeonggi-do (KR)

(72) Inventors: Dong-IL Son, Gyeonggi-do (KR); Kyoung-Sik Yoon, Busan (KR); Young-Ho Chang, Seoul (KR)

(21) Appl. No.: 14/512,183

(22) Filed: Oct. 10, 2014

(30) Foreign Application Priority Data
Oct. 10, 2013 (KR) 10-2013-0120804

(51) Int. Cl. H02J 7/04; H02J 7/02

(52) U.S. Cl. CPC H02J 7/04; H02J 7/025
USPC 307/26

(57) ABSTRACT

A method for operating an electronic device is provided. The method includes charging a battery of the electronic device. The method also includes receiving a booting input. The method further includes determining a remaining capacity of the battery. The method includes determining a charging mode of the battery when the remaining capacity of the battery is within a reference range. The method also includes booting in a booting mode corresponding to the charging mode.

### PRIORITY

The present application is related to and claims priority under 35 U.S.C. §119 to a Korean Patent Application filed on Oct. 10, 2013 in the Korean Intellectual Property Office and assigned Serial No. 10-2013-0120804, the entire contents of which are incorporated herein by reference.

### TECHNICAL FIELD

The present disclosure generally relates to a method for operating booting and an electronic device thereof.

### BACKGROUND

With the development of a multimedia technology, electronic devices having various functions have recently been developed. In general, such electronic devices have a convergence function for performing one or more functions complexly.

For example, mobile terminals such as smartphones are widely used. In particular, such mobile terminals are provided with a touch screen display module, and are also provided with a high-resolution camera module so as to provide a function of shooting a still image or a video in addition to a communication function. Furthermore, such mobile terminals may play multimedia content such as music or a video, and may be connected to a network so as to allow a user to surf websites.

Such electronic devices are provided with high-performance processors so as to perform various convergence functions more rapidly and provide high-quality services. However, due to such high-quality services, a battery replacement cycle is decreased. Wired or wireless charging devices are additionally provided to charge batteries, and booting operations may be performed by simple key manipulation.

### SUMMARY

To address the above-discussed deficiencies, it is a primary object to provide a booting operation method for preventing a battery voltage drop phenomenon when an electronic device is booted, and an electronic device therefor.

Another aspect of the present disclosure is to provide a user interface for intuitionally booting an electronic device.

Another aspect of the present disclosure is to provide a booting operation method for controlling booting of an electronic device as intended by a user, and an electronic device therefor.

In a first example, a method for operating an electronic device is provided. The method includes charging a battery of the electronic device. The method also includes receiving a booting input. The method further includes determining a remaining capacity of the battery. The method includes determining a charging mode of the battery when the remaining capacity of the battery is within a reference range. The method also includes booting in a booting mode corresponding to the charging mode.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a perspective view of an example electronic device according to this disclosure;

FIG. 2A is a block diagram illustrating an example electronic device according to this disclosure;

FIG. 2B is a block diagram illustrating an example processor according to this disclosure;

FIGS. 3 through 7 are flowcharts illustrating example methods for operating an electronic device according to this disclosure; and

FIGS. 8A, 8B and 8C are example illustrations of booting information of an electronic device according to this disclosure.

### DETAILED DESCRIPTION

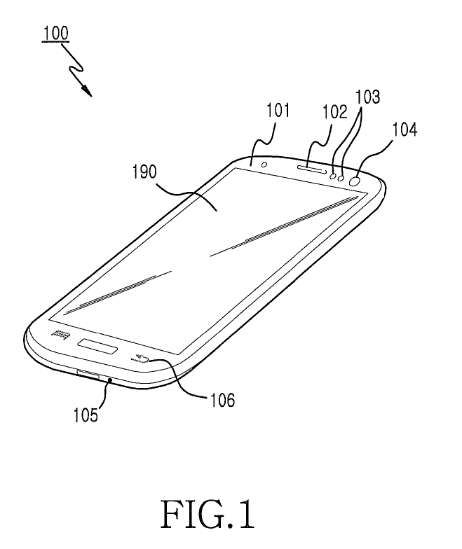

FIGS. 1 through 8C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Embodiments of the present disclosure are described in detail hereinafter with reference to the accompanying drawings. Detailed descriptions of well-known functions or constructions are omitted since they would obscure the disclosure in unnecessary detail. Also, the terms used herein are defined according to the functions of the present disclosure. Thus, the terms can vary depending on user's or operator's intentions or practices. Therefore, the terms used herein must be understood based on the descriptions made herein.

An electronic device in which a display device can be applied as a display unit is described herein in order to describe embodiments of the present disclosure, but the present disclosure is not limited thereto. For example, the electronic device can be applied to various devices including display devices, such as PDAs, laptop computers, mobile phones, smartphones, net books, TVs, mobile Internet devices (MIDs), ultra mobile PCs (UMPCs), tablet PCs, watches, camera devices, navigation devices, wearable devices, and MP3 players.

A method for operating an electronic device includes charging a battery of the electronic device, receiving a booting input, determining a remaining capacity of the battery, determining a charging mode of the battery when the remaining capacity of the battery is within a reference range, and booting in a booting mode corresponding to the charging mode. The charging the battery is performed by at least one of a wired charging technique and a wireless charging technique. The receiving of the booting input includes receiving at least one of a key button input and a connection to a charging device. The method can further include performing booting of the electronic device according to the booting input, when the remaining capacity of the battery is determined as exceeding the reference range.

In an embodiment, when the remaining capacity of the battery is within the reference range and the charging mode of the battery is a first charging mode, the booting of the electronic device is delayed by a certain time in the booting mode.

When the remaining capacity of the battery is within the reference range and the charging mode of the battery is the first charging mode, booting information of the electronic device is outputted in the booting mode.

The first charging mode includes a low-current charging mode.

The first charging mode is determined according to a predetermined charging device.

When the remaining capacity of the battery is within the reference range and the charging mode of the battery is a second charging mode, the booting of the electronic device performs in the booting mode.

The second charging mode includes a high-current charging mode.

The second charging mode is determined according to a predetermined charging device.

In an embodiment, an electronic device includes a battery, a battery charging unit, and at least one processor configured to charge the battery, receive a booting input, determine a remaining capacity of the battery, determine a charging mode of the battery when the remaining capacity of the battery is within a reference range, and control the electronic device so that the electronic device is booted in a booting mode corresponding to the charging mode.

The processor controls the battery so that the battery is charged using at least one of a wired charging technique and a wireless charging technique.

The booting input includes at least one of a key button input and a connection to a charging device.

The processor performs booting of the electronic device according to the booting input, when the remaining capacity of the battery is determined as exceeding the reference range.

The processor delays the booting of the electronic device by a certain time, when the remaining capacity of the battery is within the reference range and the charging mode of the battery is determined as a first charging mode.

The processor outputs booting information of the electronic device, when the remaining capacity of the battery is within the reference range and the charging mode of the battery is determined as a first charging mode.

The processor determines the first charging mode as a low-current charging mode.

The processor determines the charging mode as the first charging mode according to a predetermined charging device.

The processor performs the booting of the electronic device, when the remaining capacity of the battery is within the reference range and the charging mode of the battery is determined as a second charging mode.

In an embodiment, the processor determines the second charging mode as a high-current charging mode.

The processor determines the charging mode as the second charging mode according to a predetermined charging device.

FIG. 1 is a perspective view of an example electronic device 100 according to this disclosure.

Referring to FIG. 1, a display device 190 is installed on a front side 101 of the electronic device 100. The display device 190 displays a received electric signal in the form of a text, graphic or video. The display device 190 is implemented with a touch screen in which a touch sensor is applied so as to enable both input and output of data.

At an upper side of the display device 190, an ear piece 102 for receiving a voice is installed. At one side of the ear piece 102, a plurality of sensors 103 such as a proximity sensor and an illumination sensor for improving the ease of use of the electronic device and a camera module 104 for shooting an image of a subject is installed.

The electronic device 100 can further include a microphone device 105 located at a lower side of the display device 190 to receive a voice and a keypad device 106 on which key pads are arranged. However, the electronic device 100 is not limited thereto, and thus can further include various additional devices for performing other additional known functions.

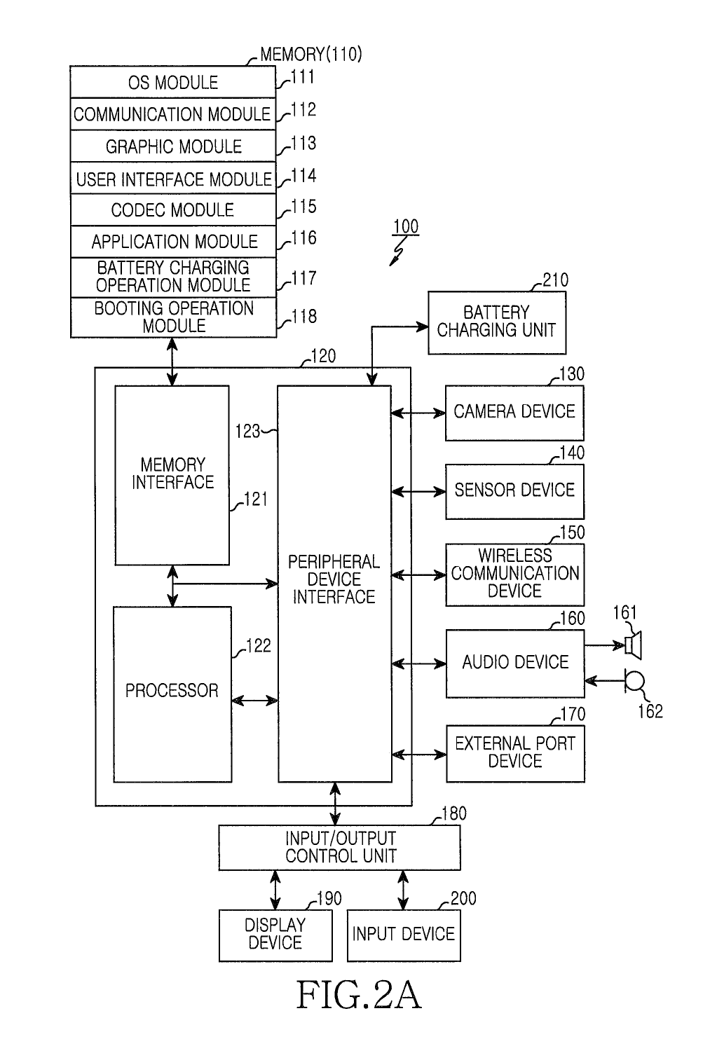

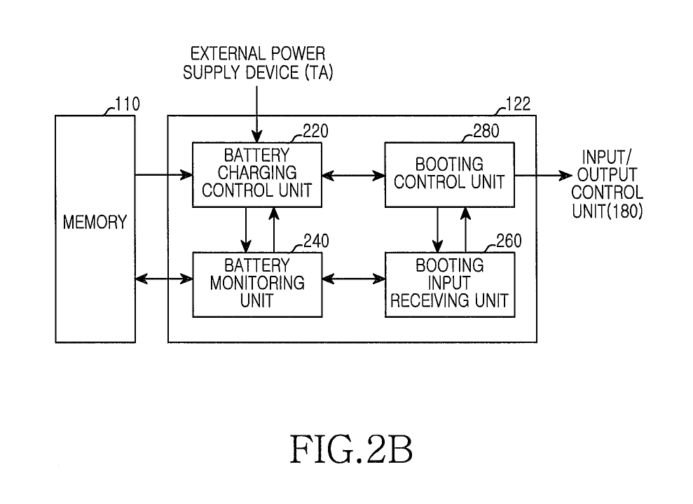

FIG. 2A is a block diagram illustrating an example electronic device 100 according to this disclosure.

Referring to FIG. 2A, the electronic device 100 can be a device such as a PDA, a laptop computer, a mobile phone, a smartphone, a net book, a hand-held computer, a mobile Internet device (MID), a media player, an ultra mobile PC (UMPC), a tablet PC, a note PC, a watch, a navigation device, an MP3 player, a camera device, or a wearable device. Furthermore, the electronic device 100 is any device having a combination of at least two functions of such devices.

In an embodiment, the electronic device 100 includes a memory 110, a processor unit 120, a camera device 130, a sensor device 140, a wireless communication device 150, an audio device 160, an external port device 170, an input/output control unit 180, a display device 190, and input device 200, and a battery charging unit 210. The memory 110 and the external port device 170 can be provided in a plurality.

The above-mentioned elements are described below.

The processor unit 120 includes a memory interface 121, at least one processor 122 and a peripheral device interface 123. Here, the memory interface 121, the at least one processor 122 and the peripheral device interface 123 included in the processor unit 120 can be integrated into at least one integrated circuit or separate elements.

The memory interface 121 controls access of the processor 122 or peripheral device interface 123 to the memory 110.

The peripheral device interface 123 controls connection between input/output peripheral devices of the electronic device 100, the processor 122, and the memory interface 121.

The processor 122 uses at least one software program to control the electronic device 100 so that the electronic device 100 provides various multimedia services. The processor 122 executes at least one program stored in the memory 110 so as to provide a service corresponding to the program.

The processor 122 executes various software programs to perform various functions for the electronic device 100, and performs a process and control for voice communication, visual communication and data communication. In addition, the processor 122 performs methods described herein in association with software modules stored in the memory 110.

The processor 122 includes at least one data processor, an image processor, or a codec. The data processor, the image processor, or the codec can be separately configured.

Various elements of the electronic device 100 are connected to each other through at least one communication bus or an electric connection unit.

The camera device 130 performs camera functions such as photographing, video clipping and recording. The camera device 130 includes a charged coupled device (CCD) or a complementary metal-oxide semiconductor (CMOS). In addition, the camera device 130 controls hardware configurations such as lens movement and the number of apertures according to an executed camera program.

The camera device 130 provides, to the processor unit 120, a collection image obtained by shooting an image of a subject. The camera device 130 includes an image sensor for converting an optical signal into an electric signal, an image signal processor for converting an analog image signal into a digital image signal, and a digital signal processor for processing an image signal output from the image signal processor so that the image signal is displayed on the display device 190.

The sensor device 140 includes a proximity sensor, a hall sensor, an illuminance sensor, and a motion sensor. For example, the proximity sensor detects an aspect that approaches the electronic device 100 and the hall sensor detects magnetism of a metallic body. The illuminance sensor detects light around the electronic device 100 and the motion sensor includes an acceleration sensor and a gyro sensor for detecting a movement of the electronic device 100. However, the sensor device 140 is not limited thereto, and thus can further include various sensors for performing other additional known functions.

The wireless communication device 150 enables wireless communication, and includes a radio frequency transmitter/receiver or a light (such as infrared light) transmitter/receiver. A radio frequency IC (RFIC) unit and a baseband processing unit can be included in the wireless communication device 150. The RFIC unit transmits/receives electromagnetic waves and converts a baseband signal into electromagnetic waves to transmit the signal through an antenna.

The RFIC unit can include a transceiver, an amplifier, a tuner, an oscillator, a digital signal processor, a codec chip set, and a subscriber identification module (SIM) card.

The wireless communication device 150 is implemented so as to he operated for at least one of a global system for mobile communication (GSM) network, an enhanced data GSM environment (EDGE) network, a code division multiple access (CDMA) network, a wideband code division multiple access (W-CDMA) network, an LTE network, an orthogonal frequency division multiple access (OFDMA) network, a Wi-Fi network, a WiMax network, a near field communication (NFC) network, an infrared communication network, and a Bluetooth network. However, the wireless communication device 150 is not limited thereto, and thus can employ various communication schemes using protocols for electronic mail, instant messaging or a short message service (SMS).

The audio device 160 is connected to a speaker 161 and a microphone 162 so as to perform audio input/output functions such as voice recognition, voice reproduction, digital recording, and making a call. The audio device 160 provides an audio interface between a user and the electronic device 100, and converts a data signal received from the processor 122 into an electric signal to output the electric signal through the speaker 161.

The speaker 161 converts the electric signal into a signal of an audible frequency band to output the electric signal, and can be arranged at the front or rear of the electronic device 100. The speaker 161 can include a flexible film speaker in which at least one piezoelectric body is attached to a single vibration film.

The microphone 161 converts sound waves received from a person or other sound sources into an electric signal. The audio device 160 receives the electric signal from the microphone 162, converts the received electric signal into an audio data signal, and transmits the audio data signal to the processor 122. The audio device 160 can include an earphone, an ear set, a headphone or a head set detachable from the electronic device 100.

The external port device 170 can directly connect the electronic device 100 to another electronic device, or can indirectly connect the electronic device 100 to another electronic device via a network (such as the Internet, an intranet, or a wireless LAN). The external port device 170 can include a USB port or a FireWire port.

The input/output control unit 180 provides an interface between input/output devices such as the display device 190 and the input device 200 and the peripheral device interface 123. The input/output control unit 180 can include a display device controller and other input device controllers.

The display device 190 outputs an electric signal received from the electronic device 100 to a screen. The display device 190 can be implemented with a touch screen to which a touch sensing technology is applied, and shows visual information, a text, a graphic or a video provided from the processor 122 to a user.

The display device 190 can display state information of the electronic device 100, a character input by a user, a video, and a still image. In addition, the display device 190 can display information related to an application run by the processor 122.

The display device 190 can employ not only capacitive, resistive, infrared and surface acoustic wave touch screen technologies but also any multi-touch sensing technology using a proximity sensor array or other elements. The display unit 190 can include at least one of a liquid crystal display (LCD), an organic light-emitting diode (OLED), an active mode organic light-emitting diode (AMOLED), a thin film transistor liquid crystal display (TFT LCD), a flexible display, and a 3D display.

The input device 200 provides input data generated by selection by a user to the processor 122 via the input/output control unit 180. The input device 200 can include a keypad including at least one hardware button and a touchpad for detecting touch information.

The input device 200 can include an up/down button for controlling volume. In addition, the input device 200 can include at least one of pointer devices such as a push button, a locker button, a locker switch, a thumb wheel, a dial, a stick, a mouse, a track ball and a stylus.

The battery charging unit 210 includes a charging integrated circuit (IC) for charging a battery installed in the electronic device 100. For example, the battery charging unit 210 can be provided with certain current by an external power supply device (such as a travel adapter (TA) charger or a micro USB) so as to charge the battery.

In an embodiment, the battery charging unit 210 can be operated wirelessly or by wire. A TA charger or a micro USB can be used for wired charging, or a microwave power transmission method, a solar condensing method, an electromagnetic induction method or a resonant method can be used for wireless charging. However, the battery charging unit 210 is not limited thereto, and thus can employ other known charging methods.

The memory 110 can include at least one high-speed random access memory such as a magnetic disk storage device or a nonvolatile memory and at least one optical storage device or a flash memory (such as a NAND memory or a NOR memory).

The memory 110 includes software with an operating system module 111, a communication module 112, a graphic module 113, a user interface module 114, a codec module 115, an application module 116, a battery charging operation module 117, and a booting operation module 118. The term “module” can be referred to as a set of commands, an instruction set, or a program.

The operating system module 111 includes a built-in operating system such as Windows, LINUX, Darwin, RTXC, UNIX, OS X, Android or VxWorks. The operating system module 111 can also include various software elements for controlling general system operation. The control of general system operation can include memory control and management, storage hardware (device) control and management, and power control and management. In addition, the operating system module 111 can perform a function for facilitating communication between various hardware (devices) and software elements (modules).

The communication module 112 enables communication with another electronic device such as a computer, a server or electronic equipment through the wireless communication device 150 or the external port device 170.

The graphic module 113 includes various software elements for providing and displaying a graphic on the display device 190. The term “graphic” can represent a text, a webpage, an icon, a digital image, a video or an animation.

The user interface module 114 includes various software elements related to a user interface. The user interface module 114 performs a control operation so that information on an application run by the processor 122 is displayed on the display device 190. Furthermore, the user interface module 114 can include information on how a state of a user interface is changed or information on conditions under which the state of the user interface is changed.

The codec module 115 includes relevant software elements for encoding and decoding a video file.

The application module 116 includes a software element for at least one application installed in the electronic device 100. The application can include a browser, an electronic mail program, a game, a short message service, a multimedia message service, a social networking service (SNS), an instant message service, a morning call application, an MPEG layer 3 (MP3) player, a scheduler, a paint application, a camera application, a word processing application, a keyboard emulator, a music player, an address book, a contact list, a widget, digital right management (DRM), voice recognition, voice reproduction, a position determining function and a location-based service. The terminal “application” can be referred to as an application program.

The battery charging operation module 117 includes a software element for operating a battery charging mode corresponding to the type of the TA. The battery charging operation module 117 includes a command and a relevant process for selecting a low-current charging mode or a high-current charging mode according to the type of the TA or a charging current charged to a battery.

The booting operation module 118 includes a software element for operating a booting mode corresponding to a charging mode of a battery. The booting operation module 118 includes a command and a relevant process for outputting booting information corresponding to a normal booting mode or a scheduled booting mode.

The processor unit 120 can include additional modules (commands) other than the above-mentioned modules.

Various functions of the electronic device 100 can be executed by software or hardware including at least one processing or application specific integrated circuit (ASIC).

In an embodiment, a power system for supplying power to various elements of the electronic device 100 can be included in the electronic device 100. The power system can include a power source (an AC power source or a battery), a power error detection circuit, a power converter, a power inverter, a charging device or a power state display device (a light-emitting diode). In addition, the electronic device 100 can include a power management and control device for generating, managing and distributing power.

The elements of the electronic device 100 according to the present disclosure have been described, but the electronic device 100 is not limited thereto. For example, the electronic device 100 can include more elements or fewer elements than those illustrated in the drawing.

FIG. 2B is a block diagram illustrating an example processor 122 according to this disclosure.

Referring to FIG. 2B, the processor 122 includes a battery charging control unit 220, a battery monitoring unit 240, a booting input receiving unit 260, and a booting control unit 280.

The elements of the processor 122 can include separate modules. However, according to another embodiment, the elements of the processor 122 can be included as software elements in a single module.

The battery charging control unit 220 executes the battery charging operation module 117 stored in the memory 110 so as to determine a charging mode of a battery. In addition, the battery charging control unit 220 controls the battery charging unit 210 to charge the battery or stop charging of the battery.

The battery charging control unit 220 recognizes the type of the external power supply device (TA) connected to the electronic device 100 to supply power thereto, so as to determine a battery charging mode corresponding to the type. For example, in the case of receiving power from a micro USB-type external power supply device, the battery charging control unit 220 short-circuits a D+ pin and a D− pin of a USB so as to identify the type of the external power supply device on the basis of whether the TA is inserted or the pins are grounded.

Although it has been described that the battery charging control unit 220 identifies the micro USB charging method, the present disclosure is not limited thereto. For example, the battery charging control unit 220 can identify various wireless charging methods in addition to a wired charging method such as the USB charging method, and can determine a battery charging mode corresponding thereto.

In an embodiment, the battery charging control unit 220 determines a charging mode according to a charging current charged to a battery. For example, the battery charging control unit 220 selects a low-current charging mode when the charging current charged to the battery is lower than a certain current and selects a high-current charging mode when the charging current charged to the battery is not lower than the certain current.

In the case of the USB charging method, the battery charging control unit 220 determines that the charging current value is lower than the certain current value so as to select the low-current charging mode.

In the case where a battery is charged through the high-current charging method other than the low-current charging method such as the USB charging method, the battery charging control unit 220 determines that a charging current charged to the battery is not lower than a certain current value so as to select the high-current charging mode. However, the battery charging control unit 220 is not limited thereto, and thus can select a plurality of charging modes according to various methods other than a current measuring method.

The battery monitoring unit 240 checks a remaining battery capacity through the battery charging control unit 220. In addition, the battery monitoring unit 240 checks whether a charging amount of a battery is not smaller than a certain amount so as to determine whether the electronic device 100 is bootable.

In an embodiment, even though a charging current required for booting is charged, a battery voltage drop phenomenon occurs when a current consumed for booting is larger than the charging current, and thus, the electronic device 100 is turned off while the electronic device 100 is booted. In this case, the battery monitoring unit 240 increases a threshold value of the charging current required for booting so as to prevent the battery voltage drop phenomenon that occurs when the electronic device 100 is booted. For example, if an established charging voltage required for booting is about 3.7 V, the charging voltage is re-set as about 3.9 V. However, the present disclosure is not limited thereto, and thus, a charging voltage value for booting can be variously set.

The booting input receiving unit 260 receives a booting input when the electronic device 100 is turned off. The booting input can be at least one of an input of a specific key and a connection to a charging device, but is not limited thereto.

The booting control unit 280 executes the booting operation module 118 stored in the memory 110 so as to boot the electronic device in a booting mode corresponding to a battery charging mode. The booting control unit 280 enters a booting mode determined according to a charging mode determined by the battery charging control unit 220.

In an embodiment, the booting control unit 280 performs a control operation so that scheduled booting is performed when the charging mode of a battery is the low-current charging mode. Here, the scheduled booting represents delaying booting of the electronic device 100 by a certain time. For example, in the case where the battery is charged using the low-current charging method such as the USB charging method, the booting control unit 280 delays the booting by the certain time.

In the case where the battery is charged using the high-current charging method, the booting control unit 280 performs a control operation so that normal booting is performed. The booting control unit 280 also outputs booting information corresponding to the scheduled booting through the input/output control unit 180.

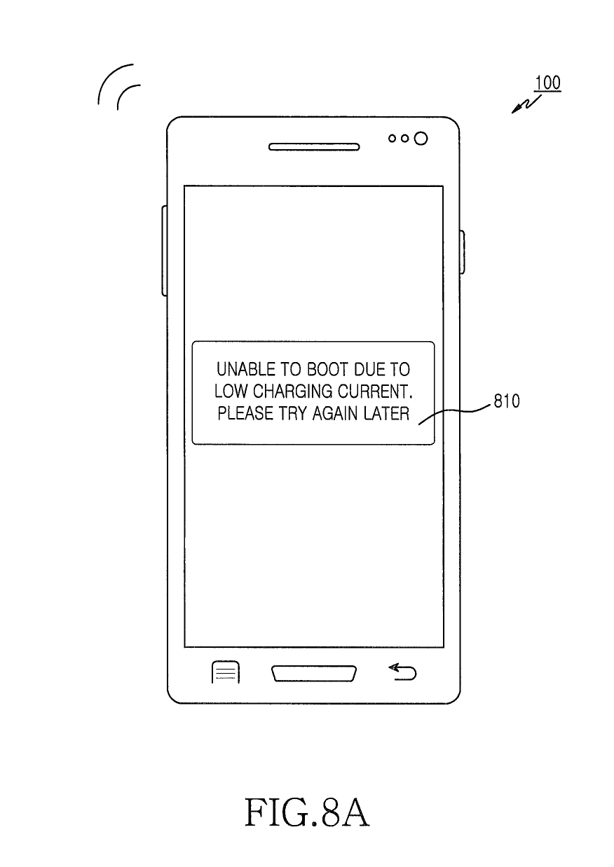

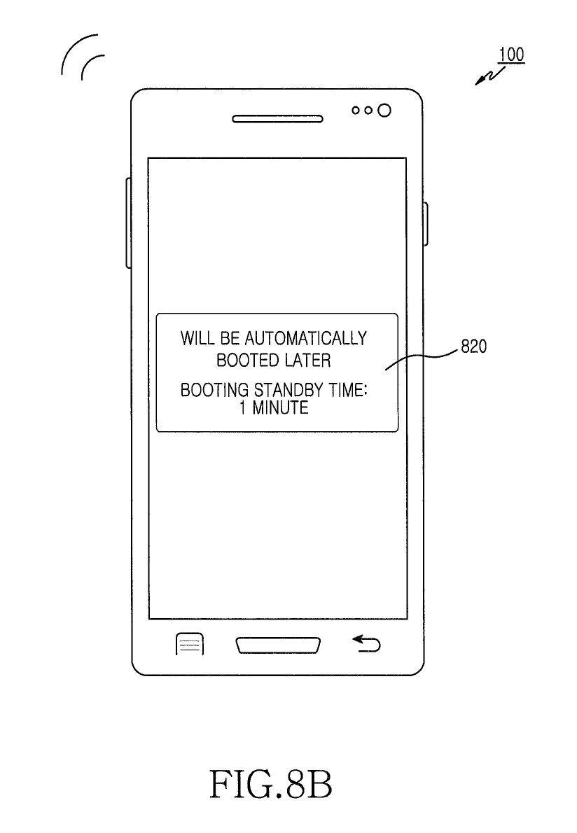

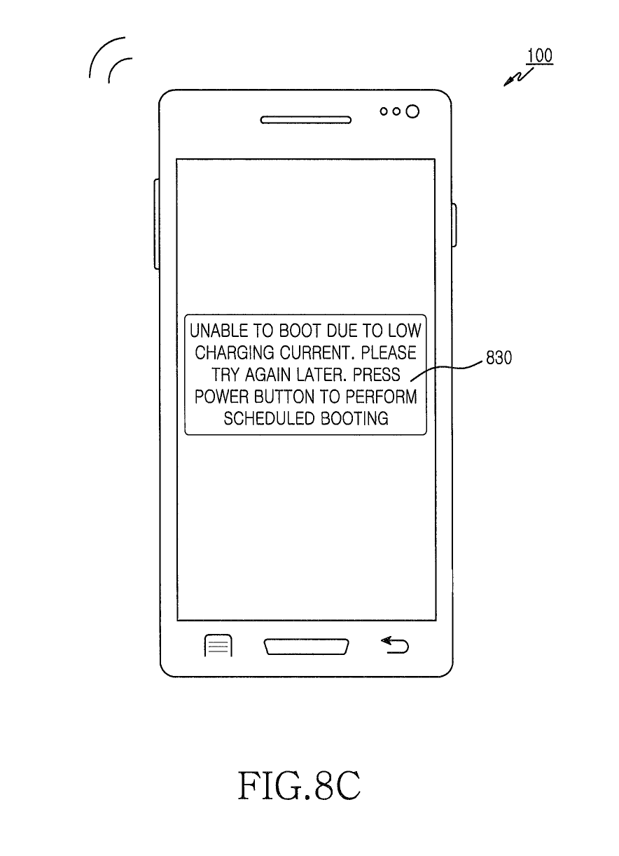

As illustrated in FIG. 8A, in the case where the battery voltage drop phenomenon occurs due to a low charging current for a battery when the booting input receiving unit 260 receives a booting input to attempt to perform booting, the booting control unit 280 outputs a booting reattempt request 810. For example, the hooting reattempt request 810 can be outputted in the form of at least one of vibration, LED indication, a text, an image and voice data.

As illustrated in FIG. 8B, in the case where the battery voltage drop phenomenon occurs due to a low charging current for a battery when the booting input receiving unit 260 receives a booting input to attempt to perform booting, the booting control unit 280 outputs scheduled booting information 820. The scheduled booting information 820 can include a booting standby time, but is not limited thereto. For example, the scheduled booting information 820 can be outputted in the form of at least one of vibration, LED indication, a text, an image and voice data.

As illustrated in FIG. 8C, in the case where the battery voltage drop phenomenon occurs due to a low charging current for a battery when the booting input receiving unit 260 receives a booting input to attempt to perform booting, the booting control unit 280 outputs a scheduled booting guide 830 for inquiring whether to perform scheduled booting. In this case, the booting control unit 280 performs the scheduled booting when a booting input is received again. For example, the scheduled booting guide 830 can be output in the form of at least one of vibration, LED indication, a text, an image and voice data. However, the present disclosure is not limited thereto, and thus, the booting information corresponding to the scheduled booting can include various content.

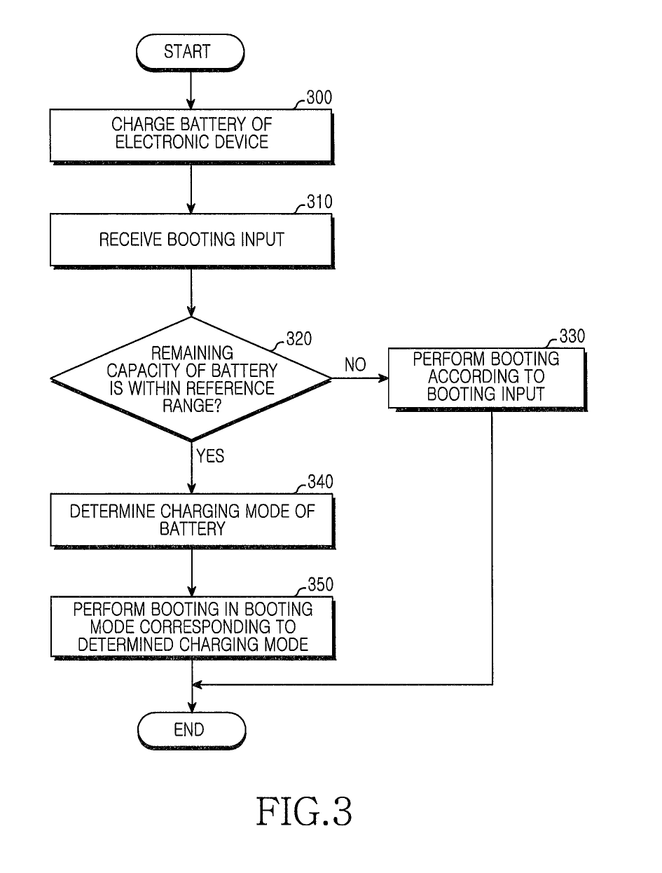

FIG. 3 is a flowchart illustrating an example method for operating an electronic device 100 according to this disclosure.

Referring to FIG. 3, the electronic device 100 charges a battery of the electronic device 100 in operation 300.

The battery charging unit 210 of the electronic device 100 includes a charging IC for charging the battery installed in the electronic device 100. For example, the battery charging unit 210 can be provided with certain current by an external power supply device (such as a TA charger or a micro USB) so as to charge the battery.

In an embodiment, the battery charging unit 210 can be operated wirelessly or by wire. The TA charger or the micro USB can be used for the wired charging, or a microwave power transmission method, a solar condensing method, an electromagnetic induction method or a resonant method can be used for the wireless charging. However, the battery charging unit 210 is not limited thereto, and thus can employ other known charging methods.

The electronic device 100 receives a booting input in operation 310.

For example, the booting input receiving unit 260 of the electronic device 100 receives the booting input when the electronic device 100 is turned off. The booting input can be an input of a specific key, but is not limited thereto.

The electronic device 100 determines whether a remaining capacity of the battery is within a reference range in operation 320.

For example, the battery monitoring unit 240 of the electronic device 100 checks the remaining battery capacity through the battery charging control unit 220. In addition, the battery monitoring unit 240 checks whether a charging amount of the battery is not smaller than a certain amount so as to determine whether the electronic device 100 is bootable.

In an embodiment, even though a charging current required for booting is charged, the battery voltage drop phenomenon occurs when a current consumed for booting is larger than the charging current, and thus, the electronic device 100 is turned off while the electronic device 100 is booted. In this case, the battery monitoring unit 240 increases a threshold value of the charging current required for booting so as to prevent the battery voltage drop phenomenon that occurs when the electronic device 100 is booted. For example, if an established charging voltage required for booting is about 3.7 V, the charging voltage is re-set as about 3.9 V. However, the present disclosure is not limited thereto, and thus, a charging voltage value for booting can be variously set.

When the remaining capacity of the battery exceeds the reference range, the electronic device 100 performs booting according to the booting input in operation 330.

The booting control unit 280 of the electronic device 100 performs a control operation so that normal booting is performed according to the booting input.

When the remaining capacity of the battery is within the reference range, the electronic device 100 determines the battery charging mode in operation 340.

For example, the battery charging control unit 220 recognizes the type of the external power supply device connected to the electronic device 220 to supply power thereto, so as to determine the battery charging mode corresponding to the type. In the case of receiving power from a micro USB-type external power supply device, the battery charging control unit 220 short-circuits a D+ pin and a D− pin of a USB so as to identify the type of the external power supply device on the basis of whether the TA is inserted or the pins are grounded.

Although it has been described that the battery charging control unit 220 identifies the micro USB charging method, the present disclosure is not limited thereto. For example, the battery charging control unit 220 can identify various wireless charging methods in addition to a wired charging method such as the USB charging method, and can determine the battery charging mode corresponding thereto.

In an embodiment, the battery charging control unit 220 determines the charging mode according to a charging current charged to a battery. For example, the battery charging control unit 220 selects a low-current charging mode when the charging current charged to the battery is lower than a certain current, and selects a high-current charging mode when the charging current charged to the battery is not lower than the certain current.

In the case of the USB charging method, the battery charging control unit 220 determines that the charging current value is lower than the certain current value so as to select the low-current charging mode.

In the case where the battery is charged through the high-current charging method other than the low-current charging method such as the USB charging method, the battery charging control unit 220 determines that the charging current value charged to the battery is not lower than the certain current value so as to select the high-current charging mode. However, the battery charging control unit 220 is not limited thereto, and thus can select a plurality of charging modes according to various methods other than the current measuring method.

The electronic device 100 is booted in a booting mode corresponding to the determined charging mode in operation 350.

For example, the booting control unit 280 of the electronic device 100 performs a control operation so that scheduled booting is performed when the charging mode of the battery is the low-current charging mode. Here, the scheduled booting represents delaying booting of the electronic device 100 by a certain time. In the case where the battery is charged using the low-current charging method such as the USB charging method, the booting control unit 280 delays the booting by the certain time.

In the case where the battery is charged using the high-current charging method, the booting control unit 280 performs a control operation so that normal booting is performed. The booting control unit 280 outputs booting information corresponding to the scheduled booting through the input/output control unit 180.

As illustrated in FIG. 8A, in the case where the battery voltage drop phenomenon occurs due to a low charging current for the battery when the booting input receiving unit 260 receives the hooting input to attempt to perform booting, the booting control unit 280 outputs the booting reattempt request 810. For example, the booting reattempt request 810 can be outputted in the form of at least one of vibration, LED indication, a text, an image, and voice data.

As illustrated in FIG. 8B, in the case where the battery voltage drop phenomenon occurs due to a low charging current for the battery when the booting input receiving unit 260 receives the booting input to attempt to perform booting, the booting control unit 280 outputs the scheduled booting information 820. The scheduled booting information 820 can include a booting standby time, but is not limited thereto. For example, the scheduled booting information 820 can be output in the form of at least one of vibration, LED indication, a text, an image, and voice data.

As illustrated in FIG. 8C, in the case where the battery voltage drop phenomenon occurs due to a low charging current for the battery when the booting input receiving unit 260 receives the booting input to attempt to perform booting, the booting control unit 280 outputs the scheduled booting guide 830 for inquiring whether to perform scheduled booting. In this case, the booting control unit 280 performs the scheduled booting when the booting input is received again. For example, the scheduled booting guide 830 can be outputted in the form of at least one of vibration, LED indication, a text, an image and voice data. However, the present disclosure is not limited thereto, and thus, the booting information corresponding to the scheduled booting can include various content.

An instruction set for each operation can be stored in the memory 110 as at least one module. In this case, the module stored in the memory 110 can be performed by at least one processor 122.

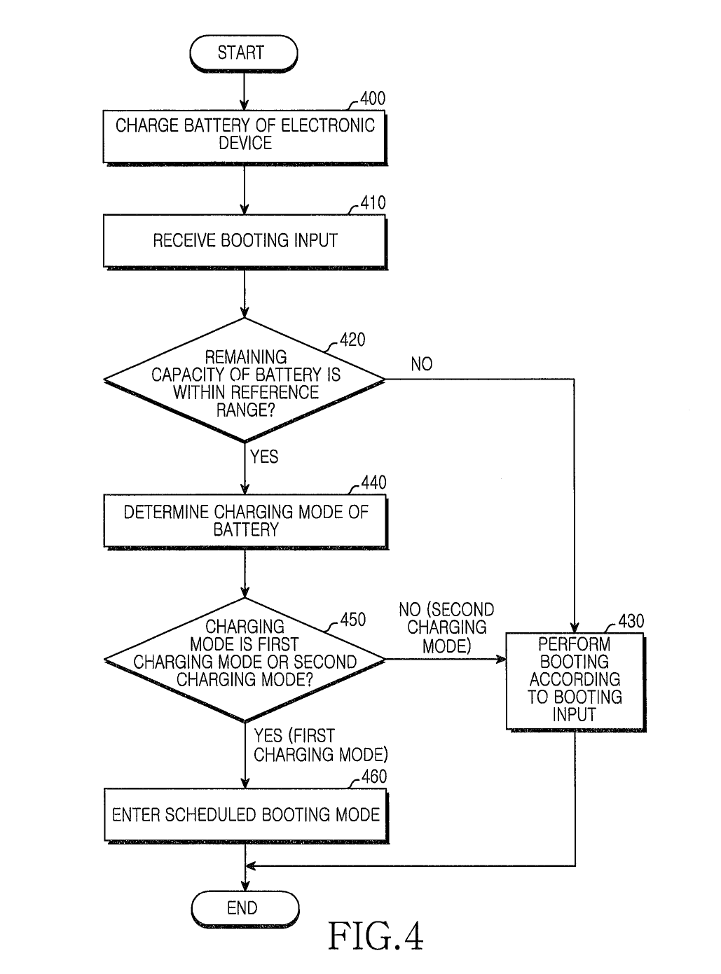

FIG. 4 is a flowchart illustrating an example method for operating an electronic device 100 according to this disclosure.

Referring to FIG. 4, the electronic device 100 charges the battery of the electronic device 100 in operation 400.

For example, the battery charging unit 210 of the electronic device 100 includes a charging IC for charging the battery installed in the electronic device 100. In an embodiment, the battery charging unit 210 is provided with certain current by an external power supply device (such as a TA charger or a micro USB) so as to charge the battery.

The battery charging unit 210 can be operated wirelessly or by wire. The TA charger or the micro USB can be used for the wired charging, or a microwave power transmission method, a solar condensing method, an electromagnetic induction method or a resonant method can be used for the wireless charging. However, the battery charging unit 210 is not limited thereto, and thus can employ other known charging methods.

The electronic device 100 receives a booting input in operation 410.

For example, the booting input receiving unit 260 of the electronic device 100 receives the booting input when the electronic device 100 is turned off. The booting input can be an input of a specific key, but is not limited thereto.

The electronic device 100 determines whether a remaining capacity of the battery is within a reference range in operation 420.

For example, the battery monitoring unit 240 of the electronic device 100 checks the remaining battery capacity through the battery charging control unit 220. In addition, the battery monitoring unit 240 checks whether a charging amount of the battery is not smaller than a certain amount so as to determine whether the electronic device 100 is bootable.

Even though a charging current required for booting is charged, the battery voltage drop phenomenon occurs when a current consumed for booting is larger than the charging current, and thus, the electronic device 100 is turned off while the electronic device 100 is booted. In this case, the battery monitoring unit 240 increases a threshold value of the charging current required for booting so as to prevent the battery voltage drop phenomenon that occurs when the electronic device 100 is booted. For example, if an established charging voltage required for booting is about 3.7 V, the charging voltage is re-set as about 3.9 V. However, the present disclosure is not limited thereto, and thus, a charging voltage value for booting can be variously set.

When the remaining capacity of the battery exceeds the reference range, the electronic device 100 performs booting according to the booting input in operation 430. For example, the booting control unit 280 of the electronic device 100 performs a control operation so that normal booting is performed according to the booting input.

When the remaining capacity of the battery is within the reference range, the electronic device 100 determines the battery charging mode in operation 440.

For example, the battery charging control unit 220 recognizes the type of the external power supply device connected to the electronic device 220 to supply power thereto, so as to determine the battery charging mode corresponding to the type. In the case of receiving power from a micro USB-type external power supply device, the battery charging control unit 220 short-circuits a D+ pin and a D− pin of a USB so as to identify the type of the external power supply device on the basis of whether the TA is inserted or the pins are grounded.

Although it has been described that the battery charging control unit 220 identifies the micro USB charging method, the present disclosure is not limited thereto. For example, the battery charging control unit 220 can identify various wireless charging methods in addition to a wired charging method such as the USB charging method, and can determine the battery charging mode corresponding thereto.

In an embodiment, the battery charging control unit 220 determines the charging mode according to a charging current charged to a battery. For example, the battery charging control unit 220 selects a low-current charging mode when the charging current charged to the battery is lower than a certain current, and selects a high-current charging mode when the charging current charged to the battery is not lower than the certain current.

In the case of the USB charging method, the battery charging control unit 220 determines that the charging current value is lower than the certain current value so as to select the low-current charging mode.

In the case where the battery is charged through the high-current charging method other than the low-current charging method such as the USB charging method, the battery charging control unit 220 determines that the charging current value charged to the battery is not lower than the certain current value so as to select the high-current charging mode. However, the battery charging control unit 220 is not limited thereto, and thus can select a plurality of charging modes according to various methods other than the current measuring method.

The electronic device 100 determines whether the charging mode is a first charging mode or a second charging mode in operation 450.

For example, the first charging mode can be a low-current charging mode. The low-current charging mode can represent the low-current charging method such as the USB charging method, but is not limited thereto. Here, the first charging mode is a charging mode corresponding to the determined type of the TA.

The second charging mode can be a high-current charging mode. For example, the high-current charging mode can represent a wireless charging method using a high charging current, but is not limited thereto. The second charging mode can be a charging mode corresponding to the determined type of the TA.

When the charging mode is the second charging mode, the electronic device 100 performs booting according to the booting input in operation 430.

For example, the booting control unit 280 of the electronic device 100 performs a control operation so that normal booting is performed according to the booting input.

When the charging mode is the first charging mode, the electronic device 100 enters a scheduled booting mode in operation 460.

For example, the booting control unit 280 of the electronic device 100 performs a control operation so that scheduled booting is performed when the charging mode of the battery is the low-current charging mode. Here, the scheduled booting represents delaying booting of the electronic device 100 by a certain time. In the case where the battery is charged using the low-current charging method such as the USB charging method, the booting control unit 280 delays the booting by the certain time. Furthermore, the booting control unit 280 outputs booting information corresponding to the scheduled booting through the input/output control unit 180.

As illustrated in FIG. 8A, in the case where the battery voltage drop phenomenon occurs due to a low charging current for the battery when the booting input receiving unit 260 receives the booting input to attempt to perform booting, the booting control unit 280 outputs the booting reattempt request 810. For example, the booting reattempt request 810 can be outputted in the form of at least one of vibration, LED indication, a text, an image and voice data.

As illustrated in FIG. 8B, in the case where the battery voltage drop phenomenon occur due to a low charging current for the battery when the booting input receiving unit 260 receives the booting input to attempt to perform booting, the booting control unit 280 outputs the scheduled booting information 820. The scheduled booting information 820 can include a booting standby time, but is not limited thereto. For example, the scheduled booting information 820 can be output in the form of at least one of vibration, LED indication, a text, an image and voice data.

As illustrated in FIG. 8C, in the case where the battery voltage drop phenomenon occurs due to a low charging current for the battery when the booting input receiving unit 260 receives the booting input to attempt to perform booting, the booting control unit 280 outputs the scheduled booting guide 830 for inquiring whether to perform scheduled booting. In this case, the booting control unit 280 performs the scheduled booting when the booting input is received again. For example, the scheduled booting guide 830 can be output in the form of at least one of vibration, LED indication, a text, an image and voice data. However, the present disclosure is not limited thereto, and thus, the booting information corresponding to the scheduled booting can include various content.

An instruction set for each operation can be stored in the memory 110 as at least one module. In this case, the module stored in the memory 110 is performed by at least one processor 122.

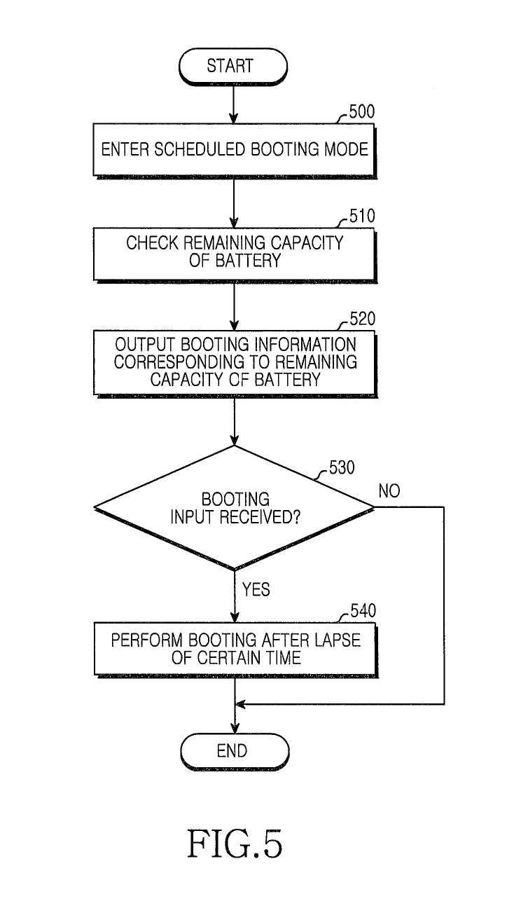

FIG. 5 is a flowchart illustrating an example method for operating an electronic device 100 according to this disclosure.

Referring to FIG. 5, the electronic device 100 enters a scheduled booting mode in operation 500.

For example, when the remaining capacity of the battery is within a reference range and the battery charging mode is the low-current charging mode, the electronic device 100 enters the scheduled booting mode. In the case where the battery is charged using the low-current charging method such as the USB charging method, the booting control unit 280 of the electronic device 100 delays the booting by the certain time.

The electronic device 100 checks the remaining capacity of the battery in operation 510.

For example, the battery monitoring unit 240 of the electronic device 100 checks the remaining battery capacity through the battery charging control unit 220.

The electronic device 100 outputs booting information corresponding to the remaining capacity of the battery in operation 520.

For example, the booting control unit 280 of the electronic device 100 outputs the booting information corresponding to the scheduled booting through the input/output control unit 180.

As illustrated in FIG. 8C, the booting control unit 280 outputs the scheduled booting guide 830 for inquiring whether to perform the scheduled booting. In this case, the booting control unit 280 performs the scheduled booting when the booting input is received again. For example, the scheduled booting guide 830 can be output in the form of at least one of vibration, LED indication, a text, an image, and voice data. However, the present disclosure is not limited thereto, and thus, the booting information corresponding to the scheduled booting can include various content.

The electronic device 100 determines whether the booting input has been received in operation 530.

For example, the booting input receiving unit 260 of the electronic device 100 receives the booting input while the scheduled booting guide 830 is output to a screen of the electronic device 100. The booting input can be an input of a specific key, but is not limited thereto.

When the booting input is received, the electronic device 100 can be booted after a lapse of a certain time in operation 540.

For example, the booting control unit 280 of the electronic device 100 performs scheduled booting. Here, the scheduled booting represents delaying booting of the electronic device 100 by a certain time.

An instruction set for each operation can be stored in the memory 110 as at least one module. In this case, the module stored in the memory 110 can be performed by at least one processor 122.

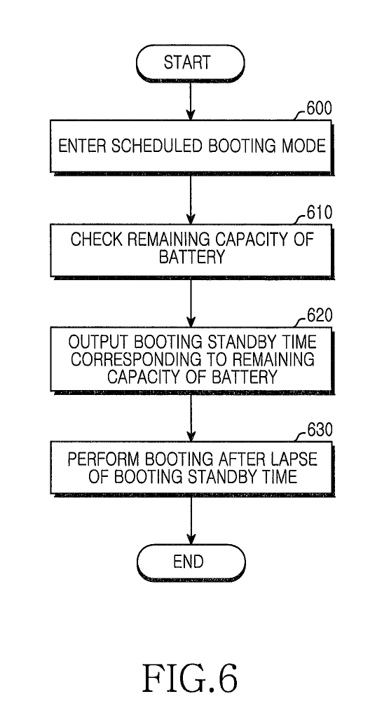

FIG. 6 is a flowchart illustrating an example method for operating an electronic device 100 according to this disclosure.

Referring to FIG. 6, the electronic device 100 enters a scheduled booting mode in operation 600.

For example, when the remaining capacity of the battery is within a reference range and the battery charging mode is the low-current charging mode, the electronic device 100 enters the scheduled booting mode. In the case where the battery is charged using the low-current charging method such as the USB charging method, the booting control unit 280 of the electronic device 100 delays the booting by the certain time.

The electronic device 100 checks the remaining capacity of the battery in operation 610.

For example, the battery monitoring unit 240 of the electronic device 100 checks the remaining battery capacity through the battery charging control unit 220.

The electronic device 100 outputs a booting standby time corresponding to the remaining capacity of the battery in operation 620.

For example, the booting control unit 280 of the electronic device 100 outputs the booting standby time for scheduled booting through the input/output control unit 180. The booting standby time can be output in the form of at least one of vibration, LED indication, a text, an image, and voice data.

The electronic device 100 performs booting after a lapse of the booting standby time in operation 630.

For example, the booting control unit 280 of the electronic device 100 performs normal booting after a lapse of the standby time.

An instruction set for each operation can be stored in the memory 110 as at least one module. In this case, the module stored in the memory 110 is performed by at least one processor 122.

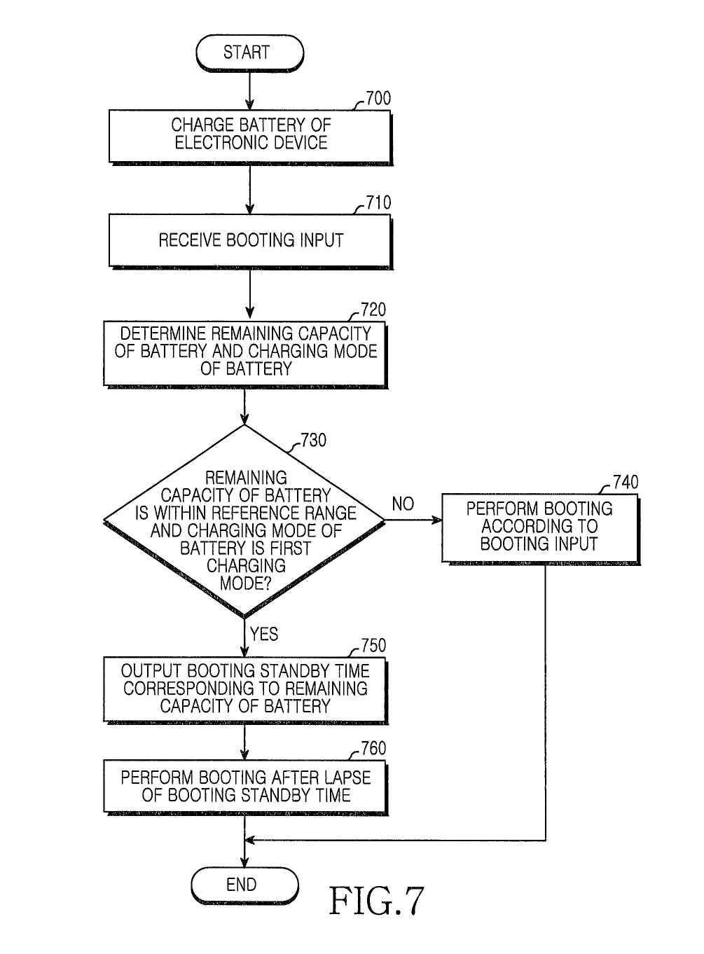

FIG. 7 is a flowchart illustrating an example method for operating an electronic device 100 according to this disclosure.

Referring to FIG. 7, the electronic device 100 charges the battery of the electronic device 100 in operation 700.

For example, the battery charging unit 210 of the electronic device 100 includes a charging IC for charging the battery installed in the electronic device 100. The battery charging unit 210 is provided with certain current by an external power supply device (such as a TA charger or a micro USB) so as to charge the battery.

In an embodiment, the battery charging unit 210 can be operated wirelessly or by wire. The TA charger or the micro USB can be used for the wired charging, or a microwave power transmission method, a solar condensing method, an electromagnetic induction method or a resonant method can be used for the wireless charging. However, the battery charging unit 210 is not limited thereto, and thus can employ other known charging methods.

The electronic device 100 receives a booting input in operation 710,

For example, the booting input receiving unit 260 of the electronic device 100 receives the booting input when the electronic device 100 is turned off. The booting input can be an input of a specific key, but is not limited thereto.

The electronic device 100 checks the remaining capacity of the battery and determines the battery charging mode in operation 720.

For example, the battery monitoring unit 240 of the electronic device 100 checks the remaining battery capacity through the battery charging control unit 220. The battery charging control unit 220 recognizes the type of the external power supply device, so as to determine the battery charging mode corresponding to the type.

The electronic device 100 determines whether the remaining capacity of the battery is within a reference range and the battery charging mode is the first charging mode in operation 730.

When the remaining capacity of the battery exceeds the reference range or the charging mode is not the first charging mode, the electronic device 100 performs booting according to a booting input in operation 740.

When the remaining capacity of the battery is within the reference range or the charging mode is the first charging mode, the electronic device 100 outputs a booting standby time corresponding to the remaining capacity of the battery in operation 750.

In an embodiment, the booting control unit 280 of the electronic device 100 outputs the booting standby time for scheduled booting through the input/output control unit 180. The booting standby time can be output in the form of at least one of vibration, LED indication, a text, an image, and voice data.

The electronic device 100 performs booting after a lapse of the booting standby time in operation 760.

For example, the booting control unit 280 of the electronic device 100 performs normal booting after a lapse of the standby time.

An instruction set for each operation can be stored in the memory 110 as at least one module. In this case, the module stored in the memory 110 is performed by at least one processor 122.

Each module can include software, firmware, hardware, or a combination thereof. A part or all of the modules can be configured in a single entity, so as to perform the same operations as those of the modules. Operations can be performed sequentially, iteratively, or in parallel. Some operations can be omitted, or other operations can be additionally performed. For example, each operation can be performed by a corresponding module described in the embodiments of the present disclosure.

In the case of implementation by software, a non-transient computer-readable storage medium for storing at least one program (software module) can be provided. The at least one program stored in the computer-readable storage medium can be performed by at least one processor in the electronic device. The at least one program can include commands for instructing the electronic device to perform the methods according to various embodiments of the present disclosure.

The program (software module or software) can be stored in a random access memory, a non-volatile memory including a flash memory, a read-only memory (ROM), an electrically erasable programmable ROM (EEPROM), a magnetic disk storage device, a compact disk ROM (CD-ROM), a digital versatile disk (DVD), another type of an optical storage device, and a magnetic cassette. Alternatively, the program can be stored in a memory configured with a combination of some or all of the above-mentioned storage devices. Furthermore, each memory can be included in a plurality.

The program can be stored in an attachable storage device that can access the electronic device via a communication network such as the Internet, an intranet, a LAN, a WLAN or a SAN or a communication network configured with a combination thereof. Such storage device can be connected to the electronic device through an external port device.

Furthermore, an additional storage device on a communication network can be connected to the electronic device.

In an embodiments, the battery voltage drop phenomenon can be prevented, and an intuitive user interface for applying an intention of a user.

While the disclosure has been shown and described with reference to certain preferred embodiments thereof, it will be understood by those skilled in the art that various changes in form and details can be made therein without departing from the spirit and scope of the disclosure as defined by the appended claims. Therefore, the scope of the disclosure is defined not by the detailed description of the disclosure but by the appended claims, and all differences within the scope will be construed as being included in the present disclosure.

What is claimed is:

1. A method in an electronic device, the method comprising:
charging a battery of the electronic device;
receiving a booting input;
detecting a remaining capacity of the battery;
determining a charging mode of the battery when the remaining capacity of the battery is within a reference range; and
booting in a booting mode corresponding to the charging mode.

2. The method of claim 1, wherein charging the battery comprises performing at least one of a wired charging technique and a wireless charging technique.

3. The method of claim 1, wherein receiving the booting input comprises receiving at least one of a key button input and a connection to a charging device.

4. The method of claim 1, further comprising performing booting of the electronic device according to the booting input, when the remaining capacity of the battery is determined as exceeding the reference range.

5. The method of claim 1, wherein, when the remaining capacity of the battery is within the reference range and the charging mode of the battery is a first charging mode, delaying the hooting of the electronic device by a certain time in the booting mode.

6. The method of claim 5, wherein, when the remaining capacity of the battery is within the reference range and the charging mode of the battery is the first charging mode, outputting booting information of the electronic device in the booting mode.

7. The method of claim 5, wherein the first charging mode comprises a low-current charging mode.

8. The method of claim 5, wherein the first charging mode is determined according to a predetermined charging device.

9. The method of claim 1, wherein, when the remaining capacity of the battery is within the reference range and the charging mode of the battery is a second charging mode, performing the booting of the electronic device in the booting mode.

10. The method of claim 9, wherein the second charging mode comprises a high-current charging mode.

11. The method of claim 9, wherein the second charging mode is determined according to a predetermined charging device.

12. An electronic device comprising:
a battery;
a battery charging unit; and
at least one processor configured to:
charge the battery,
receive a booting input,
detect a remaining capacity of the battery,
determine a charging mode of the battery when the remaining capacity of the battery is within a reference range, and
control the electronic device so that the electronic device is booted in a booting mode corresponding to the charging mode.

13. The electronic device of claim 12, wherein the processor is configured to control the battery so that the battery is charged using at least one of a wired charging technique and a wireless charging technique.

14. The electronic device of claim 12, wherein the booting input comprises at least one of a key button input and a connection to a charging device.

15. The electronic device of claim 12, wherein the processor is configured to perform booting of the electronic device according to the booting input, when the remaining capacity of the battery is determined as exceeding the reference range.

16. The electronic device of claim 12, wherein the processor is configured to delay the booting of the electronic device by a certain time, when the remaining capacity of the battery is within the reference range and the charging mode of the battery is determined as a first charging mode.

17. The electronic device of claim 16, wherein the processor is configured to output booting information of the electronic device, when the remaining capacity of the battery is within the reference range and the charging mode of the battery is determined as a first charging mode.

18. The electronic device of claim 16, wherein the processor is configured to determine the first charging mode as a low-current charging mode.

19. The electronic device of claim 16, wherein the processor is configured to determine the charging mode as the first charging mode according to a predetermined charging device.

20. The electronic device of claim 12, wherein the processor is configured to performs the booting of the electronic device, when the remaining capacity of the battery is within the reference range and the charging mode of the battery is determined as a second charging mode.

21. The electronic device of claim 20, wherein the processor is configured to determines the second charging mode as a high-current charging mode.

22. The electronic device of claim 20, wherein the processor is configured to determines the charging mode as the second charging mode according to a predetermined charging device.

23. A non-transient computer-readable storage medium for storing at least one program comprising commands for instructing the electronic device to perform the method comprising:
charging a battery of the electronic device;
receiving a booting input;
detecting a remaining capacity of the battery;
determining a charging mode of the battery when the remaining capacity of the battery is within a reference range; and
booting in a booting mode corresponding to the charging mode.
